(19) United States
(12) Patent Application Publication
(10) Pub. No.: US 2017/0039532 A1
(43) Pub. Date: Feb. 9, 2017

(54) MANAGEMENT OF FINANCIAL INSTRUMENTS

(71) Applicant: INTERNATIONAL BUSINESS MACHINES CORPORATION, Armonk, NY (US)

(72) Inventor: Arthur L. De Magalhaes, Markham (CA)

(21) Appl. No.: 14/816,110

(22) Filed: Aug. 3, 2015

(51) Int. Cl. G06Q 20/10; G06Q 20/06

(52) U.S. Cl. CPC G06Q 20/10; G06Q 20/06

(57) ABSTRACT

A method, executed by a computer, for managing financial instruments includes receiving a financial instrument value and financial instrument details for a financial instrument, wherein the financial instrument's value and the financial instrument details are extracted from an image of the financial instrument using image processing tools, and sequestering a monetary amount in a monetary account corresponding to the financial instrument details, wherein the monetary amount is equal to an exchangeable value of the financial instrument. A computer program product and computer system corresponding to the above method are also disclosed herein.

### BACKGROUND OF THE INVENTION

The present invention relates generally to financial instruments, and more specifically, to managing issued financial instruments.

Financial instruments, also known as negotiable instruments, may refer to documents that guarantee the payment of a specific amount of money, either on demand, or at a set time, with the payer and/or payee named on the document. A financial instrument may promise the payment of a monetary value without condition. Examples of financial instruments include promissory notes, bills of exchange, banknotes, and cheques/checks. Because a money amount is promised to be paid, the instrument itself can be used by the holder in due course (i.e. the payee) as a store of value.

### SUMMARY

As disclosed herein, a method, executed by a computer, for managing financial instruments includes receiving a financial instrument value and financial instrument details for a financial instrument, wherein the financial instrument's value and the financial instrument details are extracted from an image of the financial instrument using image processing tools, and sequestering a monetary amount in a monetary account corresponding to the financial instrument details, wherein the monetary amount is equal to an exchangeable value of the financial instrument. A computer program product and computer system corresponding to the above method are also disclosed herein.

### BRIEF DESCRIPTION OF THE DRAWINGS

FIG. 1 is a flowchart depicting one embodiment of a financial instrument management method in accordance with the present invention;

FIG. 2 is an illustration depicting one embodiment of a financial instrument in accordance with the present invention;

FIG. 3 is an illustration depicting one embodiment of a financial instrument image capture event in accordance with the present invention;

FIG. 4 is a block diagram depicting one embodiment of a financial instrument management system in accordance with the present invention; and

FIG. 5 is a block diagram depicting one example of a computing apparatus (i.e., computer) suitable for executing the methods disclosed herein.

### DETAILED DESCRIPTION

Embodiments of the present invention relate generally to financial instruments, and in particular, to the managing of financial instruments by the payer or issuer of the instrument. A financial instrument may include promissory notes, bills of exchange, banknotes, and/or checks. Typically, a financial instrument will include at least a payer, who is the person promising payment equal to the value of the instrument. Financial instruments may also include a payee, who is the holder in due course to whom the financial instrument's monetary value can be paid.

When a payer gives a financial instrument to a payee, the payer's banking account may not reflect the transferred value of the financial instrument until the payee deposits the instrument. If the payee retains the instrument for a length of time before depositing, the payer may forget about the issued financial instrument and inadvertently not leave enough money in the payer's account to cover the value of the instrument. When the payee ultimately does deposit the financial instrument, the payer's financial account(s) could become overdrawn. Various embodiments disclosed herein enable a payer to manage the payer's outstanding financial instruments by tracking the status of the financial instruments and by sequestering an amount of funds equal to the value of the financial instrument in the payer's account.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of the invention as set forth hereinafter. The present invention will now be described in detail with reference to the figures.

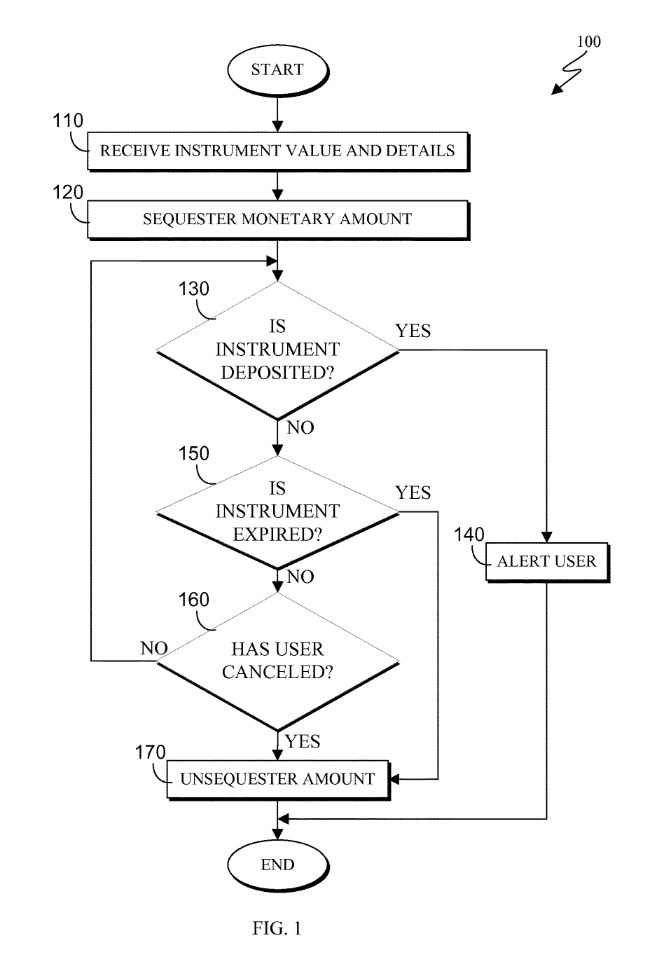

FIG. 1 is a flowchart depicting one embodiment of a financial instrument management method 100 in accordance with the present invention. As depicted, the financial instrument management method 100 includes receiving (110) instrument details, sequestering (120) an amount, determining (130) whether the instrument has been deposited, alerting (140) the user, determining (150) whether the instrument has expired, determining (160) whether the user has canceled, and unsequestering (170) the amount. The financial instrument management method 100 may enable a mobile user to track particular financial instruments by setting aside an amount of money equal to the instrument's value in the user's financial account(s).

Receiving (110) instrument details may include receiving information relating to the financial instrument. This information may include the monetary value of the financial instrument, financial instrument number, a date, the names of the payer and payee, a memo line, and/or account identifying information such as the account number or tracking number. In some embodiments, the financial instrument details are extracted from an image of the financial instrument captured by the user. In some embodiments, the financial instrument details are extracted from an image using image processing techniques. The financial instrument details may be used to determine the account against which the financial instrument is written, and the monetary amount of the financial instrument.

Sequestering (120) a monetary amount may include setting aside an amount of money equal to the value of the financial instrument in the payer's financial account to which the financial instrument is linked. In some embodiments, this monetary amount may be transferred to another account. The monetary amount may be flagged as “owed to another” and represented separately from the user's account total in any account statements. For example, if a payer writes a check to another for $100 and the payer's checking account has $1000, then the account may be reported to the payer as having simply $900, as having $900 plus $100 worth of issued financial instruments, or as having $1000 less $100. The monetary amount may also be placed into a third party escrow account.

Determining (130) whether the instrument has been deposited may include determining whether the payee has deposited the financial instrument in an account or converted the financial instrument to cash. In some embodiments, the payer and/or the payer's financial institution is informed of the fact that the payee has deposited the financial instrument. The payer may be notified that the financial instrument has been deposited by either the payer's or the payee's financial institution.

If the instrument has been deposited, then the financial instrument management method proceeds to the user alert operation 140. Otherwise, the financial instrument management method 100 proceeds to the expiration determination operation 150.

Alerting (140) the payer may include sending a notification to the payer that the financial instrument has been deposited. The notification may be delivered to the user by an automated telephone call, an SMS message, an in-app notification on a mobile device, an email, or the like. In some embodiments, the notification is sent to the payer on the same device that is executing the financial instrument management method 100. The notification may use multiple redundant notification means, or appear on multiple devices. In some embodiments, the notification includes a reminder of the value of the financial instrument and/or the payer's current account balance.

Determining (150) whether the instrument has expired may include determining whether the expiration date of the financial instrument is before or after the current date. In some embodiments, the payer financial institution is informed of the fact that the financial instrument has expired. In some embodiments, a financial instrument is automatically determined to be expired if it is not deposited or canceled within a certain time period that begins at the date that the payer authorizes the financial instrument. The date at which the payer authorizes the instrument may be the date as it appears in the date field of the financial instrument, and thus not necessarily the same date as the date that the payer endorses the financial instrument (e.g. to account for post-dated checks). In some embodiments, the payer is informed of the expired nature of the financial instrument in a similar manner as the user alert operation 140.

If the instrument has expired, then the financial instrument management method proceeds to the unsequestering operation 170. Otherwise, the financial instrument management method 100 proceeds to the cancellation determination operation 160.

Determining (160) whether the user has canceled may include receiving a notification that the financial instrument has been canceled by the payer. In some embodiments, the canceled status of the instrument is generated directly by the payer via the payer's mobile device. The cancellation notification may come through the payer's financial institution. If the cancellation determination operation 160 determines that the financial instrument was canceled, then the financial instrument management method 100 proceeds to the unsequestering operation 170; otherwise, the financial instrument management method 100 loops back to the deposit determination operation 130.

Unsequestering (170) the amount may include reversing the action(s) of the sequestering operation 120. In some embodiments, the account statement is updated to reflect that there is no outstanding financial instrument. If the value of the financial instrument was placed aside into another financial account or third-party escrow account, then the monetary amount is transferred back into the payer's financial account from whence it came.

FIG. 2 is an illustration depicting one embodiment of a financial instrument 200 in accordance with the present invention. As depicted, the financial instrument 200 includes a financial instrument number 210, date information 220, payer information 230, payee information 240, memo information 250, account identifier information 260, and financial instrument value 270. The financial instrument 200 may contain all of the information necessary to enable the payer to transfer a monetary value from a particular financial account to the payee.

The financial instrument number 210 may be a number used to track or catalogue the particular financial instrument. For example, in the case of checks, the financial instrument number 210 is a number that is incremented with each check in a checkbook. In some embodiments, the financial instrument is managed via the financial instrument number 210. Other information on the financial instrument 200 may serve as an identifier for each particular financial instrument, such as a combination of the payee's name, date, and/or amount.

The date information 220 may include a date and/or time after which the financial instrument becomes operative to the payee. The payer can choose a date that is the day in which the payer drafts the financial instrument, or post-date the date information 220 to some day in the future, which may prevent the payee from accessing the value of the financial instrument until said date arrives.

The payer information 230 may include the name of the payer, and the payee information 240 may include the name of the payee. In some embodiments, the names of the payer and payee are legal names. In the case of joint ownership of accounts (e.g. a checking account shared by spouses), more than one name may appear in the payer information 230 or payee information 240. The memo information 250 may include any details memorializing the purpose or nature of the financial instrument. For example, if the payer leases a vehicle from the payee, the payer may wish to include “car payment” in the memo information 250 to remind the payer and/or payee of the financial instrument's purpose.

The account identifier information 260 may include any information that identifies the account, such as an account number and/or tracking number. The account identifier information 260 may be used to determine the financial account and financial institution corresponding to the financial instrument.

The financial instrument value 270 may include the monetary value/amount of the financial instrument. In some embodiments, the payer will hand-write a value for the financial instrument into this field. For example, if the payer owes the payee $200, then the payer will write “$200” as the financial instrument value 270.

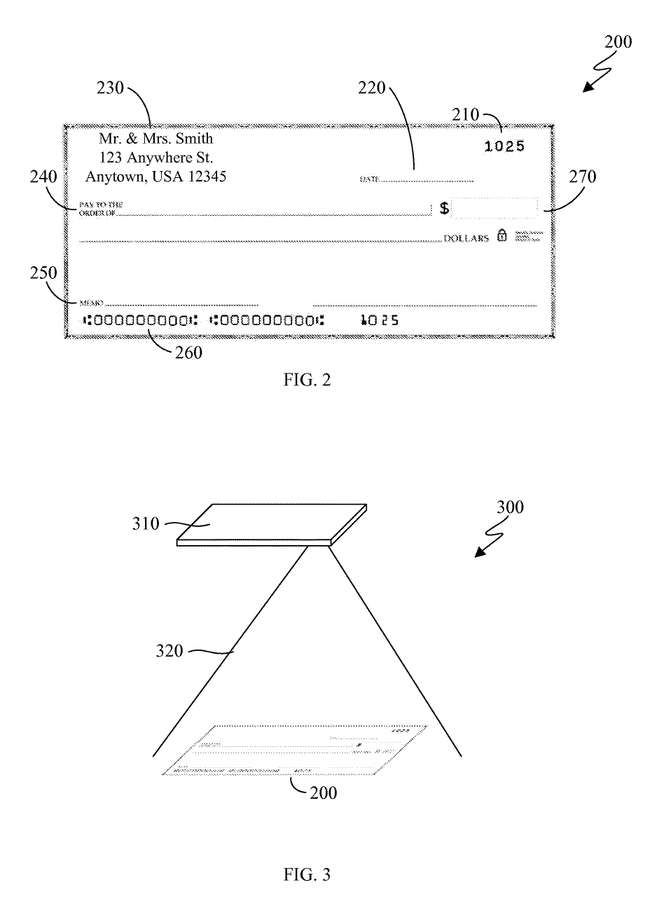

FIG. 3 is an illustration depicting one embodiment of a financial instrument image capture system 300 in accordance with the present invention. As depicted, the financial instrument image capture system 300 includes an image capture device 310, a field of view 320, and the financial instrument 200. The financial instrument image capture system 300 enables a user to translate handwriting and other information on the financial instrument 200 into computer-readable information.

The image capture device 310 may be any sort of device capable of capturing an image, performing image processing techniques on the image, and/or communicating the image or financial instrument information to a networked computer. The image capture device 310 may be a mobile device such as a smartphone, tablet, digital camera, or PDA. The field of view 320 may indicate the field of view of the camera associated with the image capture device 310. Positioning the financial instrument 200 within the field of view 320 of the image capture device 310 may enable a user to capture a complete image of the financial instrument 200 for image processing.

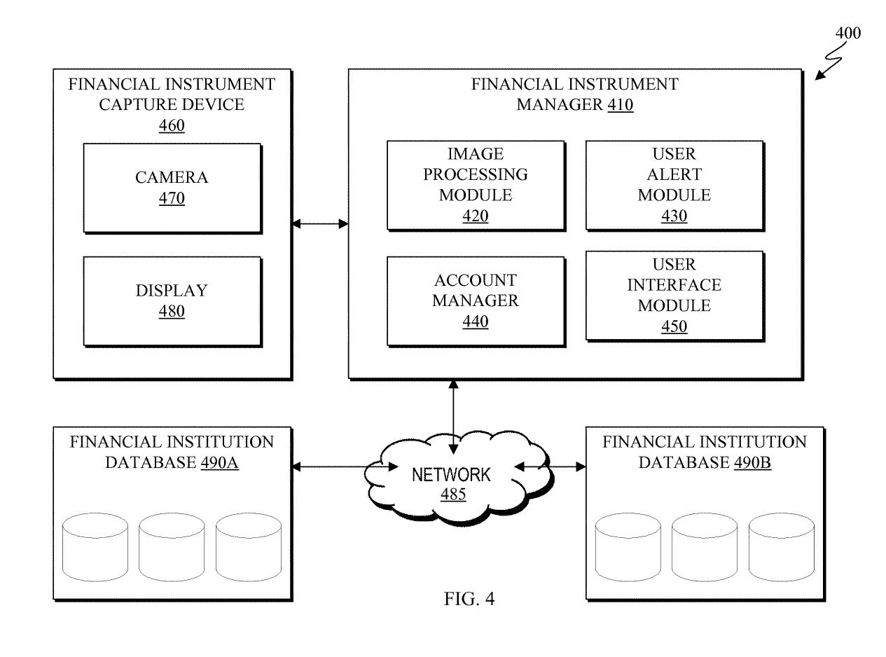

FIG. 4 is a block diagram depicting one embodiment of a financial instrument management system 400 in accordance with the present invention. As depicted, the financial instrument management system 400 includes a financial instrument manager 410 with an image processing module 420, user alert module 430, account manager 440, and user interface module 450, a financial instrument image capture device 460 with a camera 470 and display 480, a network 485, and financial institution databases 490A-490B. The financial instrument management system 400 enables a payer to manage issued financial instruments by taking a picture of the instrument, extracting information from the picture of the financial instrument, and tracking the status of the financial instrument.

The financial instrument manager 410 may include any sort of mobile device with which a payer may manage financial instruments, such as a smartphone, laptop, desktop, PDA, tablet, or the like. The financial instrument manager 410 may serve as the access point through which the payer manages financial instruments, as well as executing some or all of the operations of the financial instrument management method 100. In some embodiments, the financial instrument manager is a software application running on a smartphone.

The image processing module 420 may enable the financial instrument manager to extract meaningful information from an image of a financial instrument. The image processing module 420 may thus convert the portions of a financial instrument image corresponding to the financial instrument number 210, date information 220, payer information 230, payee information 240, memo information 250, account identifier information 260, and/or financial instrument value 270 as described with respect to FIG. 2. For example, the image processing module 420 may recognize a handwritten value of a check for $203.70 in the financial instrument value 270 field, convert this information into a monetary value 203.70, and store this monetary value as a floating-point number. Once the monetary value of the financial instrument is converted to an equivalent floating-point value measured in units of currency, the monetary value may be digitally communicated across networks, such as network 480 to financial institutions.

The user alert module 430 may enable the financial instrument manager 410 to communicate notifications to the payer regarding the status of any issued financial instruments. In some embodiments, the user alert module 430 relays communications between the financial instrument manager 410 and financial institution database(s) 490A-490B. The user alert module 430 may notify the payer by sending notifications to the financial instrument manager 410 and/or financial instrument capture device 460. In some embodiments, the user alert module 430 coordinates with the user interface module 450 to display alerts on a display 480.

The account manager 440 may track all of the payer's financial accounts. In some embodiments, the account manager 440 stores the payer's user name and password with various financial institutions so that the financial instrument manager 410 may communicate financial information between the image processing module 420 and the financial institution databases 490A-490B. In some embodiments, the account manager 440 may store the user's financial information in an encrypted or otherwise secured format.

The user interface module 450 enables the payer to access the features of the financial instrument manager 410 and/or financial instrument capture device 460 in order to manage the payer's financial instruments and financial accounts. In some embodiments, the user interface module 450 displays a graphical user interface on the display 480 or on a display (not shown) of the financial instrument manager 410.

The financial instrument capture device 460 may be used to capture images of financial instruments and communicate the images to the financial instrument manager 410. As depicted, the financial instrument capture device 460 is distinct from the financial instrument manager 410; however, the financial instrument capture device 460 and some or all of its components may or may not be physically separate from the financial instrument manager 410. The financial instrument capture device 460 may include components such as a camera 470 and display 480 to facilitate image capture. The camera 470 may be used to capture images as depicted during a financial instrument image capture system 300 as described with respect to FIG. 3. In some embodiments, the display 480 shows a preview of the image that the camera 470 will take, enabling a payer to accurately position the financial instrument capture device 460 during the financial instrument image capture system 300. In some embodiments, the financial instrument capture device 460 is a flatbed (or handheld) scanner and the financial instrument manager 410 is software running on a computing device communicatively connected to the scanner.

The network 485 may include any sort of internet, intranet, or the like, through which financial information may be communicated. In some embodiments, the network 485 is the Internet. The network 485 may ultimately enable the financial instrument manager 410 to communicate with one or more financial institution databases 490A-490B.

The financial institution databases 490A and 490B may include databases that store financial information, such as the current balances of financial accounts, as well as any outstanding credits, debits, etc., to the accounts. The depicted example shows two financial institution databases 490A and 490B; in other embodiments there may be more or fewer databases. The number of financial institution databases may depend on the number of financial accounts that a payer has.

Thus, when a payer captures an image of a financial instrument with the camera 470, the image processing module 420 may extract the monetary value of the financial instrument, and, using the account manager 440 as a bridge, report this monetary value to a database such as financial institution database 490A, so that the monetary amount may be sequestered from the remainder of the payer's account balance.

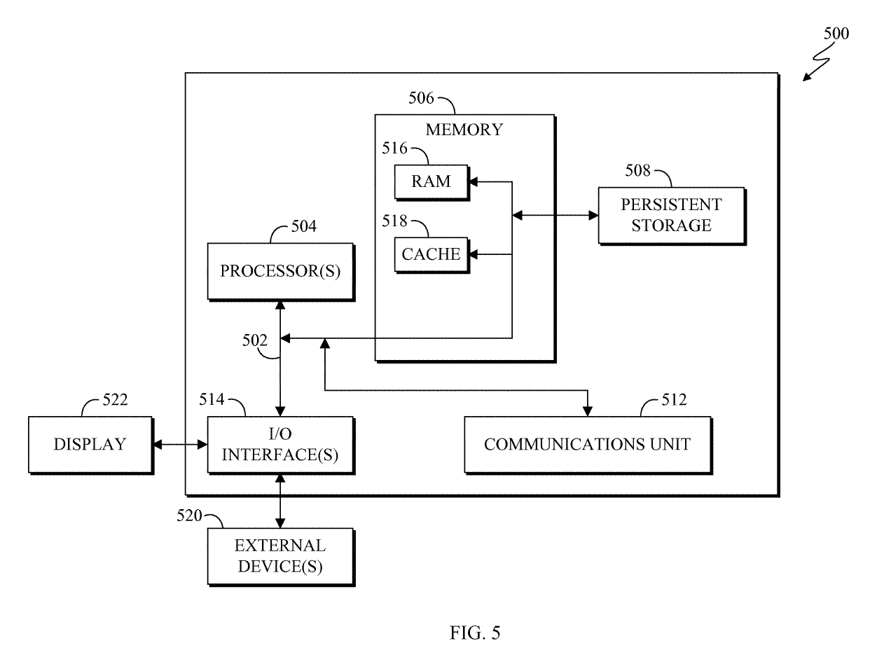

FIG. 5 is a block diagram depicting components of a computer 500 suitable for executing the methods disclosed herein. The computer 500 may be one embodiment of the systems in the financial instrument management system 400 depicted in FIG. 4. It should be appreciated that FIG. 5 provides only an illustration of one embodiment and does not imply any limitations with regard to the environments in which different embodiments may be implemented. Many modifications to the depicted environment may be made.

As depicted, the computer 500 includes communications fabric 502, which provides communications between computer processor(s) 504, memory 506, persistent storage 508, communications unit 512, and input/output (I/O) interface(s) 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In the depicted embodiment, memory 506 includes random access memory (RAM) 516 and cache memory 518. In general, memory 506 can include any suitable volatile or non-volatile computer readable storage media.

One or more programs may be stored in persistent storage 508 for execution by one or more of the respective computer processors 504 via one or more memories of memory 506. The persistent storage 508 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links.

I/O interface(s) 514 allows for input and output of data with other devices that may be connected to computer 500. For example, I/O interface 514 may provide a connection to external devices 520 such as a keyboard, keypad, a touch screen, and/or some other suitable input device. External devices 520 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 508 via I/O interface(s) 514. I/O interface(s) 514 may also connect to a display 522. Display 522 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of managing financial instruments, the method comprising:
receiving a financial instrument value and one or more financial instrument details for a financial instrument, wherein the financial instrument value and the one or more financial instrument details were extracted from an image of the financial instrument using image processing tools; and
sequestering a monetary amount corresponding to the financial instrument value in a monetary account corresponding to the one or more financial instrument details.

2. The method of claim 1, wherein the one or more financial instrument details comprises at least one of a financial instrument number, a date, payee information, payer information, account identifier information, and memo information.

3. The method of claim 1, further comprising alerting a payer when the financial instrument is deposited.

4. The method of claim 1, further comprising:
alerting a payer when the financial instrument expires; and
unsequestering the monetary amount.

5. The method of claim 1, further comprising unsequestering the monetary amount in response to a request by a payer.

6. The method of claim 1, further comprising reporting to a payer the monetary amount as a distinct amount from an original balance of the monetary account.

7. The method of claim 1, further comprising reporting to a payer a net balance of the monetary account as equal to an original balance of the monetary account minus the monetary amount.

8. A computer system for managing financial instruments, the computer system comprising:
one or more computer processors;
one or more computer readable storage media;
program instructions stored therein for execution by at least one of the one or more computer processors, the program instructions comprising instructions to:
receive a financial instrument value and one or more financial instrument details for a financial instrument, wherein the financial instrument value and the one or more financial instrument details were extracted from an image of the financial instrument using image processing tools; and
sequester a monetary amount corresponding to the financial instrument value in a monetary account corresponding to the one or more financial instrument details.

9. The computer system of claim 8, wherein the one or more financial instrument details comprises at least one of a financial instrument number, a date, payee information, payer information, account identifier information, and memo information.

10. The computer system of claim 8, further comprising instructions to alert a payer when the financial instrument is deposited.

11. The computer system of claim 8, further comprising instructions to:
alert a payer when the financial instrument expires; and
unsequester the monetary amount.

12. The computer system of claim 8, further comprising instructions to unsequester the monetary amount in response to a request by a payer.

13. The computer system of claim 8, further comprising instructions to report to a payer the monetary amount as a distinct amount from an original balance of the monetary account.

14. The computer system of claim 8, further comprising instructions to report to a payer a net balance of the monetary account as equal to an original balance of the monetary account minus the monetary amount.

15. A computer program product for managing financial instruments, the computer program product comprising:
a computer readable storage medium and program instructions stored on the computer readable storage medium, the program instructions comprising instructions to:
receive a financial instrument value and one or more financial instrument details for a financial instrument, wherein the financial instrument value and the one or more financial instrument details were extracted from an image of the financial instrument using image processing tools; and
sequester a monetary amount corresponding to the financial instrument value in a monetary account corresponding to the one or more financial instrument details.

16. The computer program product of claim 15, wherein the one or more financial instrument details comprises at least one of a financial instrument number, a date, payee information, payer information, account identifier information, and memo information.

17. The computer program product of claim 15, further comprising instructions to alert a payer when the financial instrument is deposited.

18. The computer program product of claim 15, further comprising instructions to:
alerting a payer when the financial instrument expires; and
unsequestering the monetary amount.

19. The computer program product of claim 15, further comprising instructions to unsequester the monetary amount in response to a request by a payer.

20. The computer program product of claim 15, further comprising instructions to report to a payer the monetary amount as a distinct amount from an original balance of the monetary account.
